(19) United States
(12) Patent Application Publication
(10) Pub. No.: US 2005/0088845 A1
(43) Pub. Date: Apr. 28, 2005

(54) Lighting fixture

(75) Inventor: Phil Incikaya, San Dimas, CA (US)

Correspondence Address: PERKINS COIE LLP, POST OFFICE BOX 1208, SEATTLE, WA, 98111-1208, US

(73) Assignee: P.L.I. Enterprises Inc.

(21) Appl. No.: 10/976,424

(22) Filed: Oct. 29, 2004

(51) Int. Cl. F21V 17/00

(52) U.S. Cl. 362/217; 362/147; 362/146; 362/148; 362/219

(57) ABSTRACT

A fluorescent lighting fixture has a substantially rectangular frame having a pair of opposing angled interior sidewalls. At least one lens is supportable in the frame on or between the angled interior sidewalls. A lamp holder is attached directly or indirectly to the frame, for holding one or more lamps at a position between the reflector and the aperture. A reflector is provided above the lamp. The angled interior sidewalls of the frame help to quickly and easily guide the lens into position within the lighting fixture. Light leaks are reduced or avoided. A regress divider is attached to the frame and divides the aperture defined by the frame, into first and second modules. Each module is provided with a separate lamp and lens. The modules allow for long lighting fixtures, without the need for long lamps or lenses, and without light leaks.

### BACKGROUND OF INVENTION

The field of the invention is luminaires or lighting fixtures. More specifically, the invention relates to overhead lighting fixtures. Overhead or ceiling lighting fixtures, and/or fluorescent lighting fixtures, are widely used in offices, stores, warehouses, manufacturing facilities and many other places. These fixtures are generally efficient, reliable, and economical.

A typical lighting fixture, such as a fluorescent lighting fixture, has an elongated housing, usually made of metal or plastic. One or more tubular fluorescent lamps or bulbs are contained in the fixture and shine light downwardly through an opening or aperture in the fixture. Since the lamps typically radiate light in all directions, in general, a reflector is provided in the lighting fixture, to reflect some of the upwardly emitted light from the lamps in a downward direction.

A lens or diffuser is typically attached to the housing below the fluorescent lamps. The lens is intended to distribute the light from the lamps in a more even manner, and to hide bare lamps from view or to redirect or diffuse light. If the lens is not correctly positioned in the fixture, light leaks may occur, i.e., light may shine directly from the lamp (or a reflective surface in the fixture) into the room or space below. This can cause uneven lighting, bright spots, glare, or other unwanted results. Light leaks are often caused by misaligned lenses, a gap between the lens and the reveal or trim of the lighting fixture, or due to holes, slots or cracks in fixture, lens or surrounding frame. Accordingly, there remains a need for a lighting fixture having a reliable and effective design for correctly positioning the lens, and more generally, for avoiding light leaks.

While modern lamps may have a relatively long useful life, they eventually fail and must be replaced. The design of the lighting fixture affects the time and effort required for changing a lamp. Current lighting fixture designs have met with varying degrees of success in terms of ease of changing lamps. Some fixtures have a regressed lens, or a lens which lies above the bottom plane of the fixture. Typically, in these fixtures, the lens is regressed, or offset upwardly in the fixture, by from about ½ to 2, 3, 4, 5 or more inches. Regressed lens fixtures can provide lighting and appearance that is more desirable in certain places. On the other hand, installation and removal of a regressed lens, to change a lamp, is typically more difficult than with a non-regressed lens fixture. Accordingly, it is an object of the invention to provide a lighting fixture that can be quickly and easily removed for re-lamping or changing the lamp, without tools, and with minimum effort needed to properly replace the lens after the new lamp is installed. It is a further object of the invention to provide such an advantage in a regressed lens lighting fixture.

Lighting fixtures of varying lengths are often needed to provide appropriate lighting in a room or office. Since the downward facing surface of the lighting fixture is generally visible, the aesthetics of the fixture may be significant. It can therefore become important to have a lighting fixture design that be provided in varying lengths, while maintaining the aesthetics of a uniform external appearance. Often, long fixtures are needed. However, using long lenses and lamps can be difficult, as they can be difficult to manufacture, package, store, ship, handle or install. Accordingly, it is an object of the invention to provide lighting fixtures which can be provided in varying lengths, without the need for long lenses or lamps, while still providing good lighting performance.

### SUMMARY OF THE INVENTION

In a first aspect, a lighting fixture has a substantially rectangular frame having a pair of opposing angled interior sidewalls. At least one lens is supportable in the frame on or between the angled interior sidewalls. A lamp holder or pair of sockets holds one or more lamps at a position between the reflector and an opening or aperture of the fixture. The angled interior sidewalls of the frame help to quickly and easily guide the lens into position within the lighting fixture. As a result, light leaks and uneven lighting are reduced or avoided. The lens is generally a flat plastic translucent sheet.

In a second and separate aspect, a regress divider is attached to the frame and divides the aperture or the downward facing opening formed by the frame, into first and second modules. Each module is provided with a separate lamp and lens. This use of modules allows for long lighting fixtures, without the need for long lamps or lenses, and without light leaks. Each module can have one lamp, or multiple lamps, typically arranged in a parallel array.

In a third and separate aspect, the frame is formed via mitered extruded aluminum sections. These sections provide a strong, light and aesthetic design.

Other objects and features will be apparent to those skilled in the art from the following description and drawings. While the drawings show two embodiments, they are not intended as a limit on the invention. Rather, the drawings are examples of ways that the invention can be made and used. The invention resides as well in subcombinations of the elements described.

### BRIEF DESCRIPTION OF THE DRAWINGS

FIG. 1 is bottom and side perspective view of the lighting fixture of the invention.

FIG. 2 is a top and side perspective view of the lighting fixture shown in FIG. 1.

FIG. 3 is a partial section view of the lighting fixture of FIGS. 1 and 2.

FIG. 4 is a bottom and side perspective view of another lighting fixture design having first and second modules.

FIG. 5 is a partial section view of the lighting fixture shown in FIG. 4.

FIG. 6 is a bottom view of the lighting fixture shown in FIG. 4.

FIG. 7 is a partial section view taken along line 7-7 of FIG. 6.

FIG. 8 is section view of the lighting fixture shown in FIGS. 6 and 7, in a typical ceiling installation.

FIG. 9 is section view of the lighting fixture of FIG. 1, showing installation of the lens.

FIGS. 10 and 11 are partial section views showing movement of the lens to replace a lamp in the fixture of FIG. 4.

FIG. 12 is a section view of an extrusion that can be advantageously used to make the frame of the fixtures shown in FIGS. 1 and 4.

### DETAILED DESCRIPTION OF THE DRAWINGS

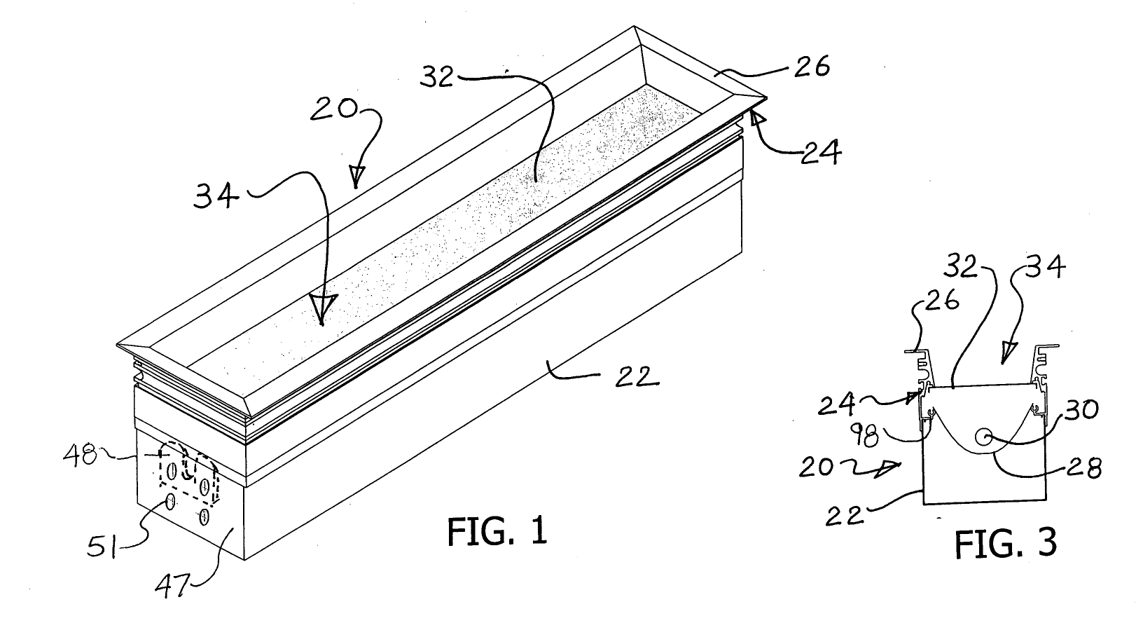

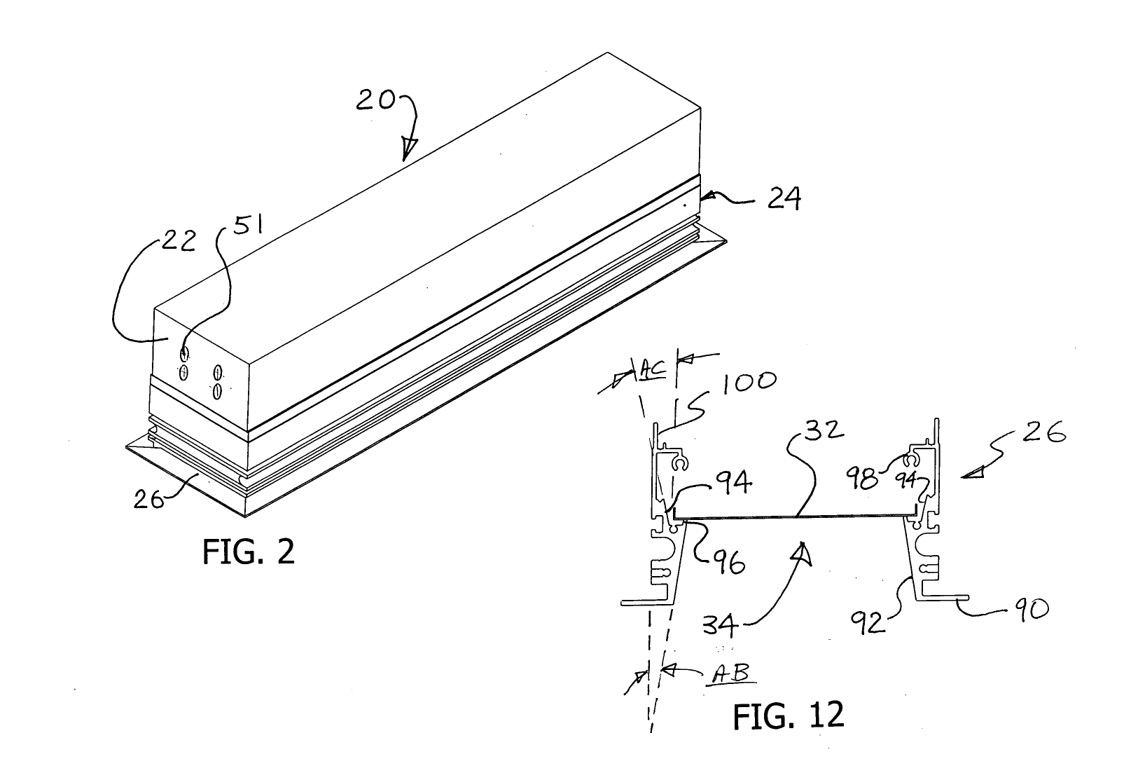

Turning now in detail to the drawings, as shown in FIGS. 1-3, a luminaire or lighting fixture 20 has a frame 24 attached to a housing 22. The frame 24 can advantageously be made from sections of an aluminum extrusion, for example, the extrusion shown in FIG. 12. The extrusion sections are joined at the corners via adhesives, welding, or mechanical fasteners or attaching devices. The housing 22, which may be steel, aluminum, plastic, or other material, is attached to the top of the frame 24, in a similar way. The frame 24 defines or forms an opening or aperture 34. A lens or diffuser 32 covers the aperture 34. The lens is typically a flat translucent plastic element or sheet, such as acrylic or polycarbonate.

As shown in FIG. 3, at least one bulb or lamp 30 is positioned between the lens 32 and a reflector 28. The reflector 28 typically is a highly reflective surface, such as a polished metal. The reflector may have a curvature designed to reflect light towards the lens 32 and out of the fixture 20 through the aperture 34. The lamp or bulb 30 is typically a tubular fluorescent lamp, although other types may also be used.

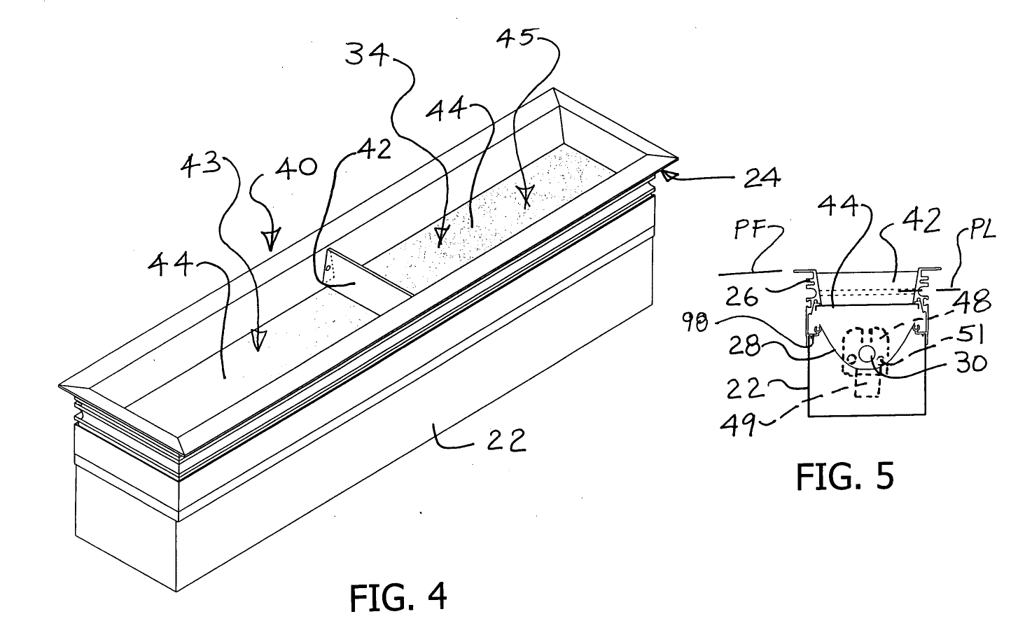

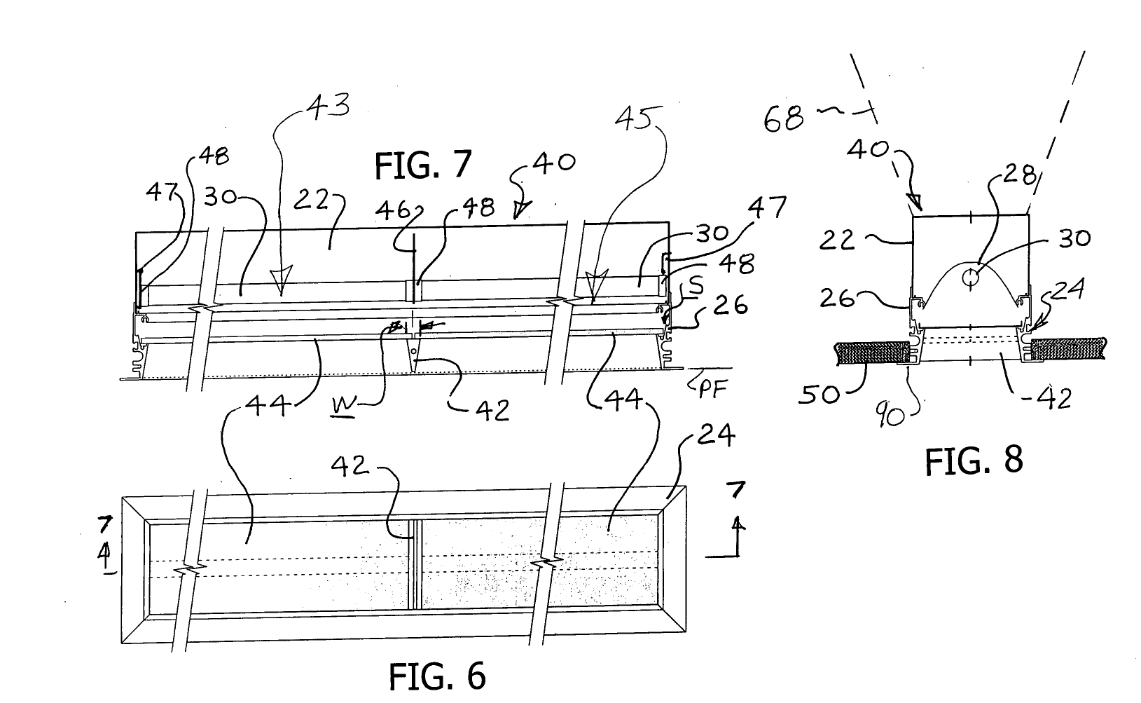

FIGS. 4-7 show an alternative embodiment, similar to the design shown in FIG. 1, but having two modules, generally designated at 43 and 45. The fixture 40 has a housing 22 and a frame 24, which may be similar or the same as the housing and frame of the lighting fixture shown in FIG. 1, or alternatively, longer than the frame and housing of FIG. 1. FIGS. 1 and 4 both show a regressed lighting fixture, i.e., a lighting fixture where the plane of the lens 32, indicated at PL in FIG. 5, is above the plane of the bottom of the frame 24, indicated at PF in FIG. 5. As shown in FIG. 4, a regress divider 42 and a module plate 46 divide the fixture 40 into two sections or modules 43 and 45, with each module having its own separate lens 44 and lamp 30. As shown in FIGS. 4, 6, and 7, the regress divider 42 has a generally triangular cross section. The bottom edge of the regress divider is approximately flush, or slightly above the plane PF of the frame 24. As shown in FIGS. 6 and 7, the opposing or facing inside ends of the lenses 44 are supported on the wider top end or surface of the regress divider 42. This helps to avoid light leaks around the divider 42.

Referring to FIGS. 5 and 7, sockets or lamp holders 48 are attached to the divider plate 46 in the housing 22. Sockets 48 are also attached to an end plate 47 of the housing 22. Screws or other fasteners 51 secure the sockets 48 in place, as shown in FIG. 1. As shown in FIG. 5, reflector brackets 49 are also attached to the end plates 47 of the housing 22. The reflector 28 is secured in place within the housing 22 via fasteners (e.g., screws or rivets), attaching the reflector 28 to the reflector brackets 49. As shown in FIGS. 3 and 5, the edges of the reflector may be held in place by arms of the frame extrusion sections 26 extending inwardly. FIG. 8 shows a typical installation. The fixture 20 (or 40) is supported by support wires 68 attached to an overhead structure (not shown). The frame 24 of the fixture engages edges of sealing tiles 50. While the drawings show fixtures with a single lamp 30 (in each module), two (or more) lamps may also be used in each module.

As shown in FIG. 12, the extrusion section 26 has a foot or rim 90 defining the bottom surface or plane PF of the frame 24. Aperture walls 92 taper inwardly towards the aperture 34. Lens walls 94 taper outwardly (opposite to the direction of the aperture walls 92) and extend upwardly from a lens ledge or rim 96. Reflector arms 98 extend inwardly from a housing flange 100 joined to the lens walls 94. The aperture walls 92 incline inwardly at an angle AB as they extend up from the rim 90. As shown in FIG. 12, the angle AB ranges from 5-20 or 8-12 degrees. The lens wall 94 tapers outwardly at angle AC, which also generally ranges from about 5-20 degrees, from vertical. In use, the rim 90 of the frame 24 is visible. Accordingly, the rim 90, or the entire frame 24 may be manufactured to achieve any desired appearance.

In use, as shown in FIGS. 10 and 11, the fixtures 20 or 40 can be quickly and easily re-lamped. Referring to FIG. 10, in a fixture 40 having two or more modules, the lens 44 is initially pushed up and lifted off the lens rim 96. The lens 44 is then moved or slid sideways into the next adjacent module, as shown in dotted lines in FIG. 10. The lamp 30 can then be removed and replaced with a new lamp, as shown in FIG. 11. After the new lamp is installed, the lens 44 is moved back into its original position. Accordingly, even though the lens 44 is regressed, movement of the lens for re-lamping can be quickly and easily achieved. In addition, since the lens 44 remains within the fixture during re-lamping, the lens 44 is less subject to damage from handling.

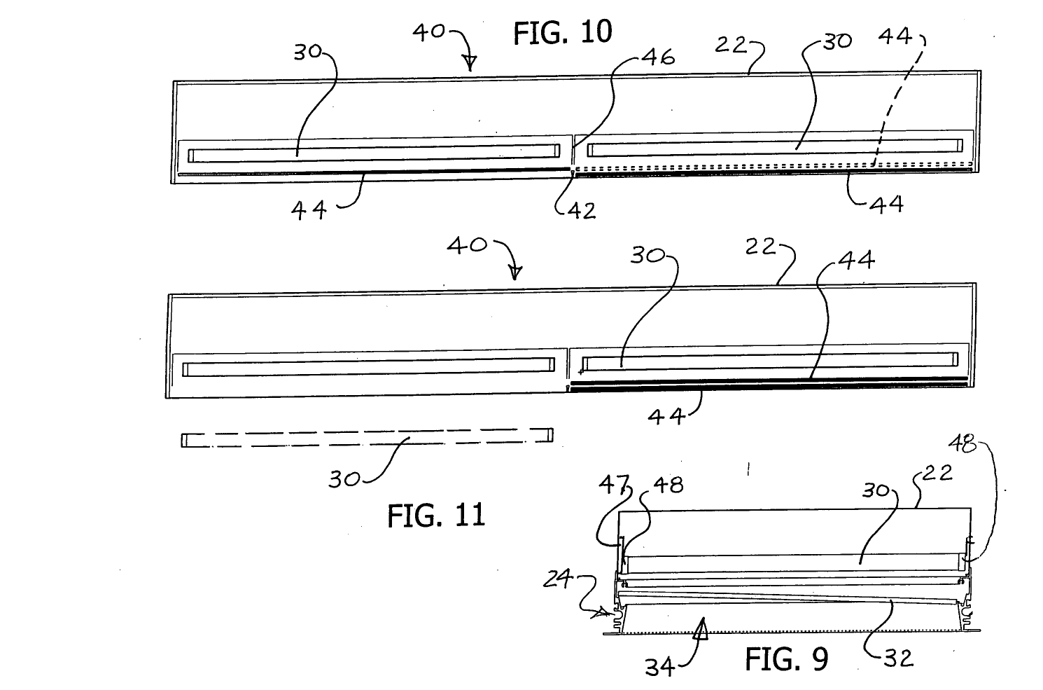

In the single module fixture 20 shown in FIGS. 1-3, there is only a single lens 32. In this embodiment, as shown in FIG. 9, the lens 32 is removed by tilting up one side of the lens, until the other side clears the lens rim 96. The lens 32 can then be lowered out of the frame 24, and the lamp 30 replaced.

The term lens here means an element which allows at least some light to pass through, regardless of the material, shape, or other characteristics of the element. The term lampholder here means an element for holding a lamp typically, but not necessarily, a pair of lamp sockets, such as the sockets 48 shown in FIG. 5. The term lamp here means a light emitting element typically, but not necessarily, a bulb or tube, such as a fluorescent bulb. The term reflector here means an element which reflects light typically, but not necessarily, a reflective curved surface such as the reflector 28 shown in FIG. 5. The reflector can also simply be a surface of the housing 22, or inherent in the lamp 30. Substitutions of equivalents of the materials and manufacturing methods described (e.g., use of extrusions) may of course be made.

Electrical wiring, connections, ballasts, and other electrical components are well known in the lighting fixture field and are not shown or described.

While FIG. 4 shows a fixture 40 having a two modules, similar fixtures having three, four, five, or more modules may also use the design of FIG. 4. The use of modules, as shown in FIG. 4, allows for continuous linear construction of the fixture, instead of having separate individual fixtures for every individual lamp or bulb needed. The use of a fixture 40 having modules 43 and 45, as shown in FIG. 4, provides for a long fixture accommodating multiple lamps, virtually end to end. The need for long lamps, or long lenses, is avoided. Having multiple modules, as shown in FIG. 4, also provides a more aesthetic appearance than putting multiple single modules together, end to end. A multiple module fixture 40, as shown in FIG. 4, also is more easily manufactured and installed in comparison to an equivalent number of single module fixtures.

Referring to FIGS. 1, 4, 8 and 12, the reveal is the part of the fixture below the level of the lens, which is visible when occupants of the building or room look up towards the ceiling. In this case, the reveal includes the rim 90 and aperture walls 92, which are part of the frame 24. In the design shown, the frame 24 and the reveal elements 90 and 92 are formed as a single, integral, or unitary piece. No pieces or components of the fixture need be removed to re-lamp (i.e., to change the lamp). As shown in FIG. 8, the ceiling elements (such as acoustic tiles) are engaged, supported, or attached around the fixture. No movement of the fixture, or any fixture component (other than the lens), and no movement of any ceiling element, is needed during re-lamping. Since only the lens 32 or 44 is moved or removed from the fixture during re-lamping, initial installation, or routine maintenance, there are no other fixture components to be removed, adjusted, or handled. Consequently, potential for misalignment, misplacement, or damage to fixture components is reduced. In addition, the potential for creating light leaks during installation, maintenance, or re-lamping is significantly reduced. The appearance of the reveal is also improved. In an alternative embodiment, which may be useful in some applications, the frame or reveal elements may be made movable or removable, for example, with the frame or reveal having two or more pieces, and with one or more of the pieces moveable for maintenance.

As shown in FIG. 7, the lens 44 is longer than the aperture 34 covered by the lens. This allows greater dimensional tolerances during cutting or manufacture of the lens 32 or 44, while still having the lens completely cover the aperture, and thereby avoid light leaks. The lens can also expand as it heats up, without jamming against the inside walls of the fixture or adjacent lenses. The width W of the divider 42, and the width of the reveal spaces S at the ends of the fixture (shown in FIG. 7), allows the lenses to expand and contract while still completely covering the aperture and preventing light leaks.

Thus, while two embodiments have been shown and described, various changes and substitutions could of course be made, without departing from the spirit and scope of the invention. The invention, therefore, should not be limited, except to the following claims, and their equivalents.

1. A lighting fixture comprising:
a substantially rectangular frame having a pair of opposing angled interior sidewalls, and with an aperture formed within the frame;
at least one lens supportable in the frame, with opposite edges of the frame on the opposing angled sidewalls;
a reflector; and
a lamp holder attached directly or indirectly to the frame, for holding a lamp at a position between the reflector and the aperture.

2. The lighting fixture of claim 1 further comprising a regress divider attached to the frame and dividing the aperture into first and second modules.

3. The lighting fixture of claim 1 further comprising a housing attached to the frame.

4. The lighting fixture of claim 1 further comprising a lamp in the lamp holder.

5. The lighting fixture of claim 1 with the frame comprising mitered extruded aluminum sections.

6. The lighting fixture of claim 3 further comprising a ballast attached to the housing.

7. The lighting fixture of claim 1 wherein the lens comprises a flat translucent element.

8. The lighting fixture of claim 2 wherein the regress divider has a generally triangular cross section.

9. The lighting fixture of claim 1 further comprising a second lamp holder for holding a second lamp.

10. A fluorescent ceiling luminaire comprising:
a generally rectangular frame having a pair of parallel interior sidewalls, with each of the sidewalls having an angled lens supporting surface;
a divider separating the frame into first and second modules;
a housing attached to the frame;
a reflector substantially contained within the housing;
a lamp holder for holding a lamp adjacent to the reflector;
a first lens supported in the first module, at least on the angled lens supporting surfaces of the pair of interior sidewalls; and
a second lens supported in the second module, at least on the angled lens supporting surfaces of the pair of interior sidewalls.

11. The lighting fixture of claim 10 with the frame comprising mitered extruded aluminum sections.

12. The lighting fixture of claim 10 further comprising a ballast attached to the housing.

13. The lighting fixture of claim 10 wherein the lenses comprise flat translucent elements.

14. The lighting fixture of claim 10 wherein the divider has a generally triangular cross section.

15. The lighting fixture of claim 10 further comprising a second lamp holder for holding a second lamp.

16. A lighting fixture comprising:
a substantially rectangular frame having a pair of opposing angled interior sidewalls, and with an aperture formed within the frame;
a reflector;
a lamp holder attached directly or indirectly to the frame, for holding a lamp at a position between the reflector and the aperture; and
at least one lens supportable in the frame, with opposite edges of the frame on the opposing angled sidewalls, and with the lens displaceable for changing the lamp, without moving any part of the frame.

17. The lighting fixture of claim 16 with the frame comprising a single unit having no moveable parts.

18. The lighting fixture of claim 17 with the frame comprising extrusion sections attached together to form the single unit.

19. The lighting fixture of claim 18 further comprising a regress divider permanently attached to the frame and dividing the aperture into first and second modules.
